(19) United States
(12) Patent Application Publication
(10) Pub. No.: US 2022/0326382 A1
(43) Pub. Date: Oct. 13, 2022

(54) ADAPTIVE POINT CLOUD GENERATION FOR AUTONOMOUS VEHICLES

(71) Applicant: Motional AD LLC, Boston, MA (US)

(72) Inventors: Yimu Wang, Pittsburgh, PA (US); Ning Xu, Pittsburgh, PA (US)

(21) Appl. No.: 17/227,253

(22) Filed: Apr. 9, 2021

(51) Int. Cl. G01S 17/42; G01S 17/931; G01S 7/48; B60W 60/00

(52) U.S. Cl. CPC G01S 17/42; G01S 17/931; G01S 7/4802; B60W 60/001; B60W 2420/52

(57) ABSTRACT

Methods, apparatus, and systems for adaptive point cloud filtering for an autonomous vehicle are disclosed. At least one processor receives multiple LiDAR points from a LiDAR system. The multiple LiDAR points represent at least one object in an environment traveled by the vehicle. The at least one processor determines a Euclidean distance of each LiDAR point. The at least one processor compares the Euclidean distance of each LiDAR point with a respective sampled Euclidean distance from a standard normal distribution of Euclidean distances. Responsive to the Euclidean distance of a LiDAR point being less than the respective sampled Euclidean distance, the at least one processor removes the LiDAR point from the multiple LiDAR points to generate a point cloud. The at least one processor operates the vehicle based on the point cloud.

### FIELD OF THE INVENTION

This description relates generally to operation of vehicles and specifically to adaptive point cloud generation for autonomous vehicles.

### BACKGROUND

LiDAR sensors and systems are often used by autonomous vehicles for localization and object perception. However, the LiDAR point clouds acquired using LiDAR systems sometimes contain redundant information and non-uniform density distributions. As a result, the computational complexity of processing such LiDAR point clouds can increase and pose challenges to efficient and safe operation of autonomous vehicles.

### SUMMARY

Methods, apparatus, and systems for adaptive point cloud generation for autonomous vehicles are disclosed. In an embodiment, at least one processor of a vehicle receives multiple LiDAR points from a LiDAR system of the vehicle. The multiple LiDAR points represent at least one object in an environment traveled by the vehicle. The at least one processor determines a Euclidean distance of each LiDAR point of the multiple LiDAR points. The at least one processor compares the Euclidean distance of each LiDAR point of the multiple LiDAR points with a respective sampled Euclidean distance from a standard normal distribution of Euclidean distances. Responsive to the Euclidean distance of a LiDAR point of the multiple LiDAR points being less than the respective sampled Euclidean distance, the at least one processor removes the LiDAR point from the multiple LiDAR points to generate a point cloud. The at least one processor operates the vehicle based on the point cloud.

In an embodiment, the multiple LiDAR points have a first density variation and the point cloud has a second density variation less than the first density variation.

In an embodiment, generating the point cloud includes down-sampling, by the at least one processor, the multiple LiDAR points to provide the second density variation.

In an embodiment, removing the LiDAR point from the multiple LiDAR points is based on the first density variation.

In an embodiment, the at least one processor determines a likelihood of adding the LiDAR point to the point cloud based on the first density variation.

In an embodiment, the at least one processor compares a measurement range of the LiDAR system with a distance from the LiDAR system to the at least one object.

In an embodiment, the LiDAR system includes at least one LiDAR. The at least one processor determines the measurement range of the LiDAR system based on the speed of light and a pulse-repetition-frequency of the at least one LiDAR.

In an embodiment, the at least one processor determines the respective sampled Euclidean distance as a random number.

In an embodiment, the at least one processor segments the point cloud based on the second density variation to identify the at least one object.

In an embodiment, operating the vehicle is further based on the segmented point cloud to avoid a collision with the at least one object.

In an embodiment, the at least one processor reduces an amount of noise in the point cloud based on the second density variation.

In an embodiment, the at least one processor smoothes the point cloud based on the second density variation.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 is a block diagram illustrating an example of an autonomous vehicle (AV) having autonomous capability, in accordance with one or more embodiments.

FIG. 2 is a block diagram illustrating an example “cloud” computing environment, in accordance with one or more embodiments.

FIG. 3 is a block diagram illustrating a computer system, in accordance with one or more embodiments.

FIG. 4 is a block diagram illustrating an example architecture for an AV, in accordance with one or more embodiments.

FIG. 5 is a block diagram illustrating an example of inputs and outputs that may be used by a perception module, in accordance with one or more embodiments.

FIG. 6 is a block diagram illustrating an example of a LiDAR system, in accordance with one or more embodiments.

FIG. 7 is a block diagram illustrating the LiDAR system in operation, in accordance with one or more embodiments.

FIG. 8 is a block diagram illustrating the operation of the LiDAR system in additional detail, in accordance with one or more embodiments.

FIG. 9 is a block diagram illustrating the relationships between inputs and outputs of a planning module, in accordance with one or more embodiments.

FIG. 10 illustrates a directed graph used in path planning, in accordance with one or more embodiments.

FIG. 11 is a block diagram illustrating the inputs and outputs of a control module, in accordance with one or more embodiments.

FIG. 12 is a block diagram illustrating the inputs, outputs, and components of a controller, in accordance with one or more embodiments.

FIG. 13 is a schematic illustrating an example of adaptive point cloud generation for autonomous vehicles, in accordance with one or more embodiments.

FIG. 14 is a schematic illustrating example LiDAR point clouds for autonomous vehicles, in accordance with one or more embodiments.

FIG. 15 illustrates an example process for adaptive point cloud generation for autonomous vehicles, in accordance with one or more embodiments.

FIG. 16 illustrates an example point cloud generated using single LiDAR scan and adaptive point cloud generation for autonomous vehicles, in accordance with one or more embodiments.

FIG. 17 illustrates an example point cloud generated using single LiDAR scan and adaptive point cloud generation for autonomous vehicles, in accordance with one or more embodiments.

FIG. 18 illustrates an example point cloud generated using single LiDAR scan and adaptive point cloud generation for autonomous vehicles, in accordance with one or more embodiments.

FIG. 19 illustrates an example point cloud generated using single LiDAR scan and adaptive point cloud generation for autonomous vehicles, in accordance with one or more embodiments.

FIG. 20 illustrates an example point cloud generated using accumulated LiDAR scans and adaptive point cloud generation for autonomous vehicles, in accordance with one or more embodiments.

FIG. 21 illustrates an example point cloud generated using accumulated LiDAR scans and adaptive point cloud generation for autonomous vehicles, in accordance with one or more embodiments.

FIG. 22 illustrates an example point cloud generated using accumulated LiDAR scans and adaptive point cloud generation for autonomous vehicles, in accordance with one or more embodiments.

FIG. 23 illustrates an example point cloud generated using accumulated LiDAR scans and adaptive point cloud generation for autonomous vehicles, in accordance with one or more embodiments.

FIG. 24 is a flow diagram illustrating a process for adaptive point cloud generation for autonomous vehicles, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in an embodiment.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Autonomous Vehicle Inputs

5. Autonomous Vehicle Planning

6. Autonomous Vehicle Control

7. Autonomous Vehicle Operation Using Adaptive Point Cloud Generation

8. Processes for Adaptive Point Cloud Generation

### General Overview

This document presents methods, systems, and apparatuses for adaptive point cloud generation for autonomous vehicles (AVs). An objective of the disclosed adaptive point cloud generation techniques is to obtain lower-variation LiDAR point clouds that are more effective for further processing and AV operation. In some embodiments, statistical processing is used to determine whether to include (e.g., add) or forego including each LiDAR point included in a LiDAR point cloud generated by a LiDAR system in a point cloud that is output for use by one or more systems in an AV. In an example, determination of whether to include or forego including each point is based on distribution characteristics of the LiDAR points included in the LiDAR point cloud. Since, in practice, many (if not most) LiDAR points are associated with (e.g., grouped at) distances closer to the LiDAR sensors, and hence closer LiDAR points have more redundant information. The LiDAR points are down-sampled by distance, such that a closer LiDAR point is more likely to be removed than a further away LiDAR point.

The advantages and benefits of adaptive point cloud generation for AVs using the embodiments described include filtering raw LiDAR point clouds to generate a point cloud that represents a portion of an environment while at the same time requires less computation by downstream systems during operation of the AVs. The implementations described also increase the overall robustness of the LiDAR data while obviating the need for additional parameters. The methods are computationally efficient and, hence, enable real-time point cloud processing. The implementations improve localization, perception, and prediction of objects that depend on LiDAR point clouds. Further, the system described for point cloud generation provides an efficient pre-processing step for applications, such as point cloud segmentation, de-noising, and smoothing for operation of AVs.

### System Overview

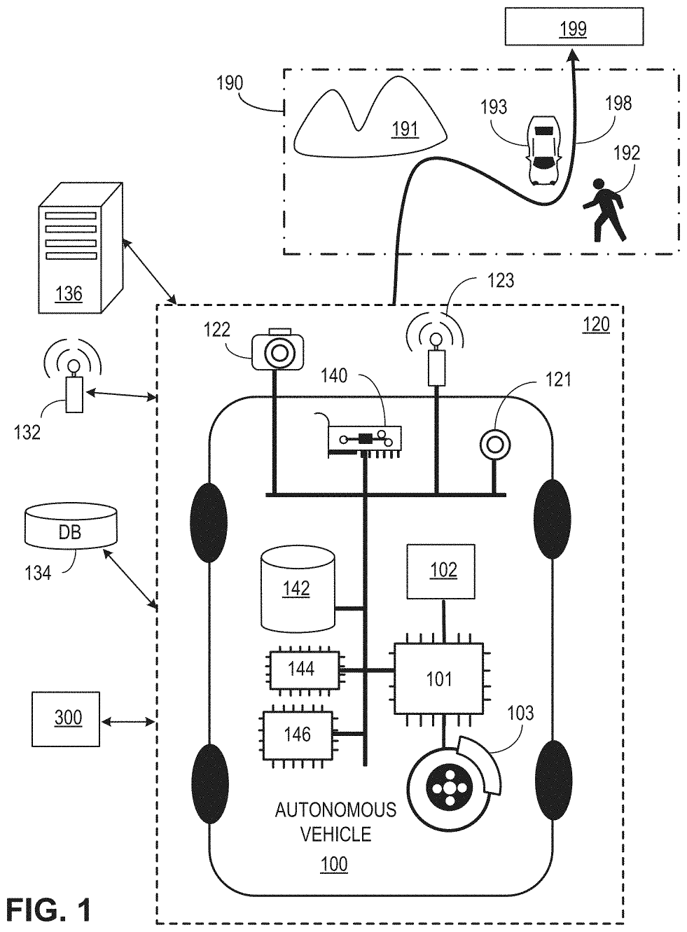

FIG. 1 is a block diagram illustrating an example of an autonomous vehicle 100 having autonomous capability, in accordance with one or more embodiments.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to operate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings or having two lanes between the lane markings. A lane could also be interpreted in the absence of lane markings. For example, a lane may be defined based on physical features of an environment, e.g., rocks and trees along a thoroughfare in a rural area.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

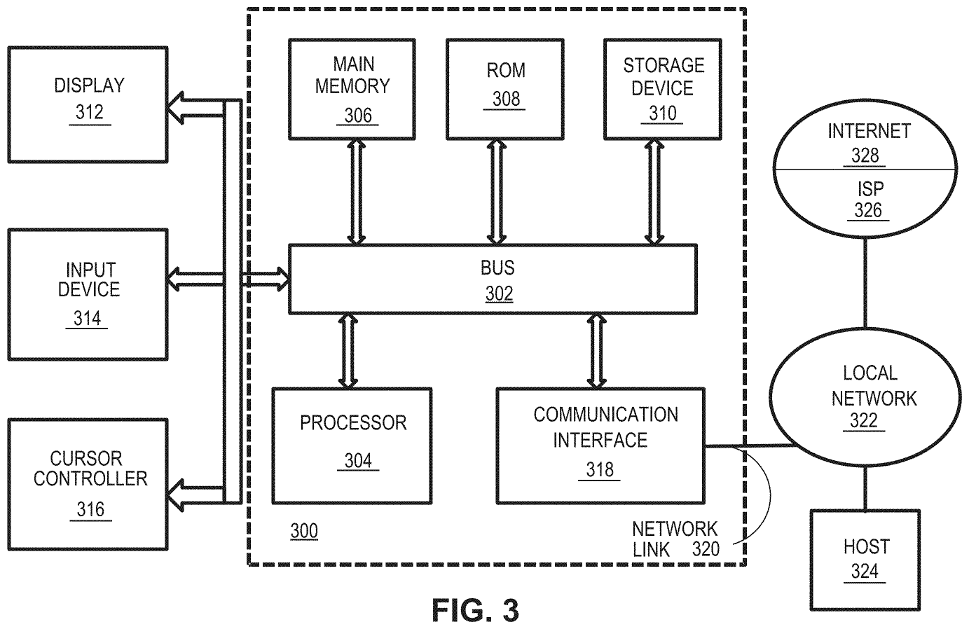

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are GNSS, inertial measurement units (IMU) that measure both vehicle linear accelerations and angular rates, wheel sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in an embodiment, one or more other types of communication) is sometimes referred to as Vehicle-to-Everything (V2X) communication. V2X communication typically conforms to one or more communications standards for communication with, between, and among autonomous vehicles.

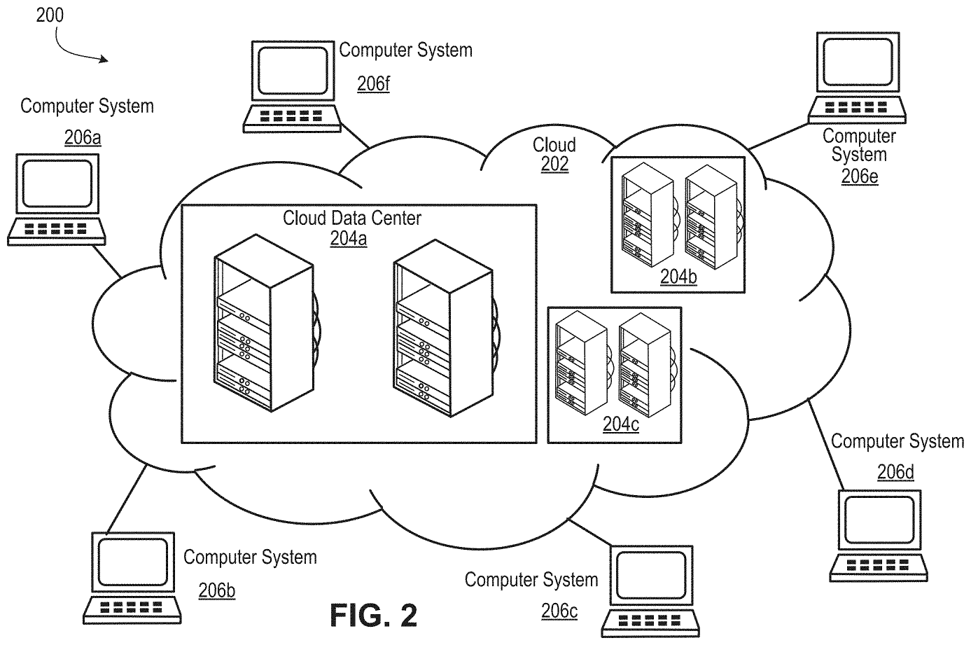

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In an embodiment, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

### Example Cloud Computing Environment

FIG. 2 is a block diagram illustrating an example “cloud” computing environment, in accordance with one or more embodiments. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In an embodiment, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

### Computer System

FIG. 3 is a block diagram illustrating a computer system 300, in accordance with one or more embodiments. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

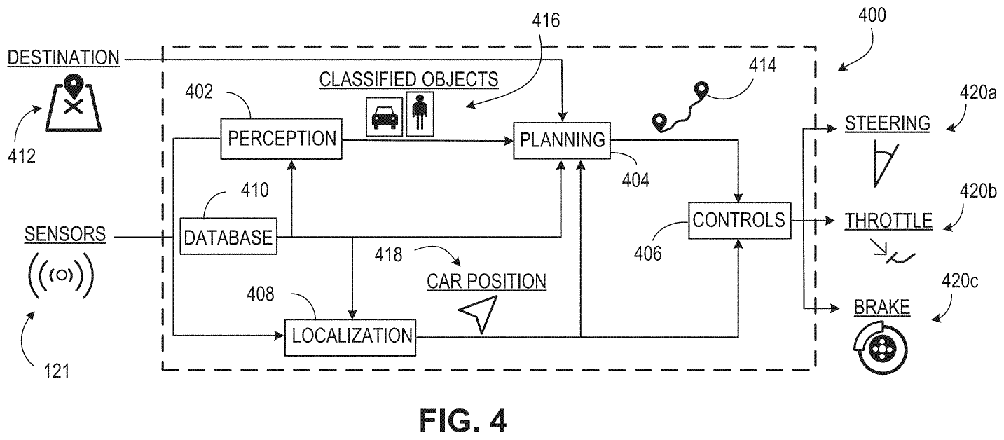

FIG. 4 is a block diagram illustrating an example architecture 400 for an autonomous vehicle (e.g., the AV 100 shown in FIG. 1), in accordance with one or more embodiments. The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In an embodiment, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a global navigation satellite system (GNSS) unit and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

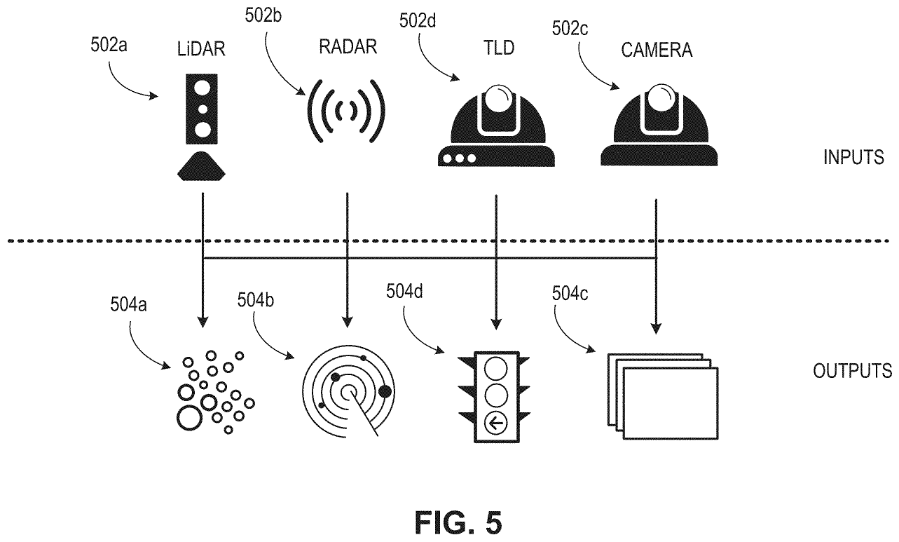

FIG. 5 is a block diagram illustrating an example of inputs 502a-d (e.g., sensors 121 shown in FIG. 1) and outputs 504a-d (e.g., sensor data) that is used by the perception module 402 (FIG. 4), in accordance with one or more embodiments. One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual operation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual operation information as possible, so that the AV 100 has access to all relevant operation information provided by these objects. For example, the viewing angle of the TLD system may be about 120 degrees or more.

In an embodiment, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In an embodiment, an early fusion technique is used. An early fusion technique is characterized by combining outputs before one or more data processing steps are applied to the combined output. In an embodiment, a late fusion technique is used. A late fusion technique is characterized by combining outputs after one or more data processing steps are applied to the individual outputs.

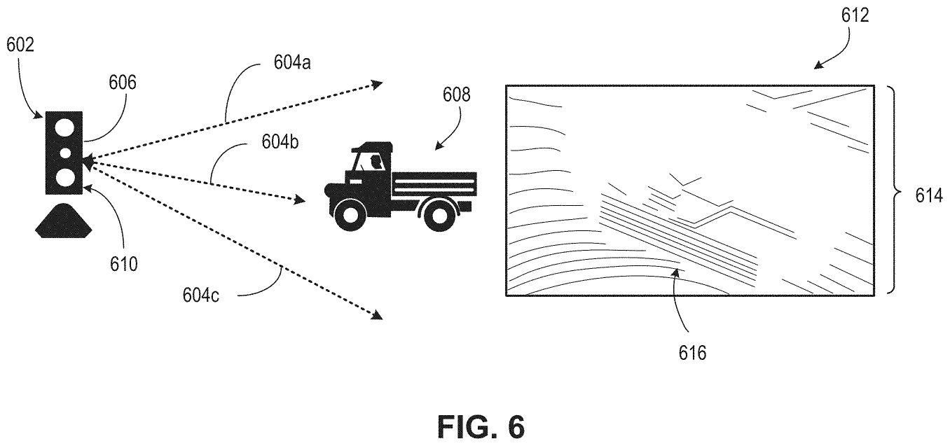

FIG. 6 is a block diagram illustrating an example of a LiDAR system 602 (e.g., the input 502a shown in FIG. 5), in accordance with one or more embodiments. The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

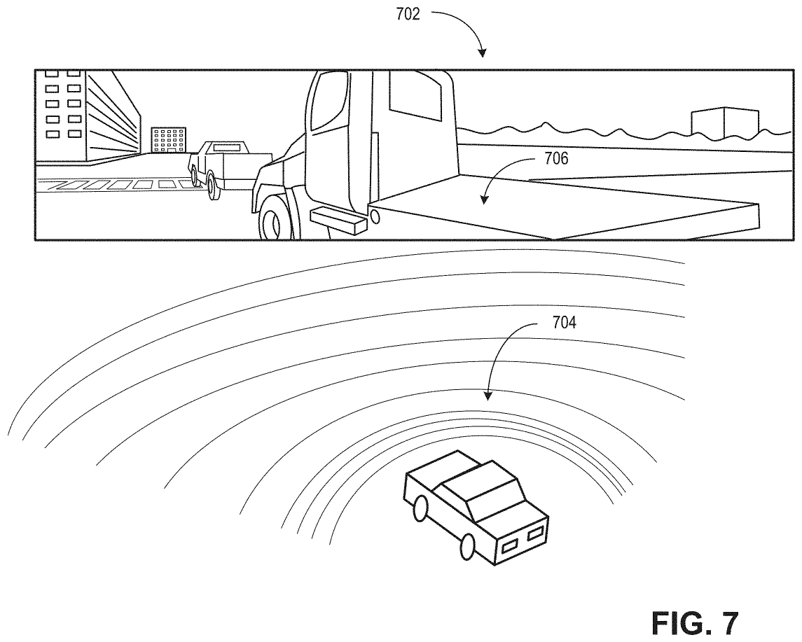

FIG. 7 is a block diagram illustrating the LiDAR system 602 in operation, in accordance with one or more embodiments. In the scenario shown in this figure, the AV 100 receives both camera system output 504c in the form of an image 702 and LiDAR system output 504a in the form of LiDAR data points 704. In use, the data processing systems of the AV 100 compares the image 702 to the LiDAR data points 704. In particular, a physical object 706 identified in the image 702 is also identified among the LiDAR data points 704. In this way, the AV 100 perceives the boundaries of the physical object based on the contour and density of the data points 704.

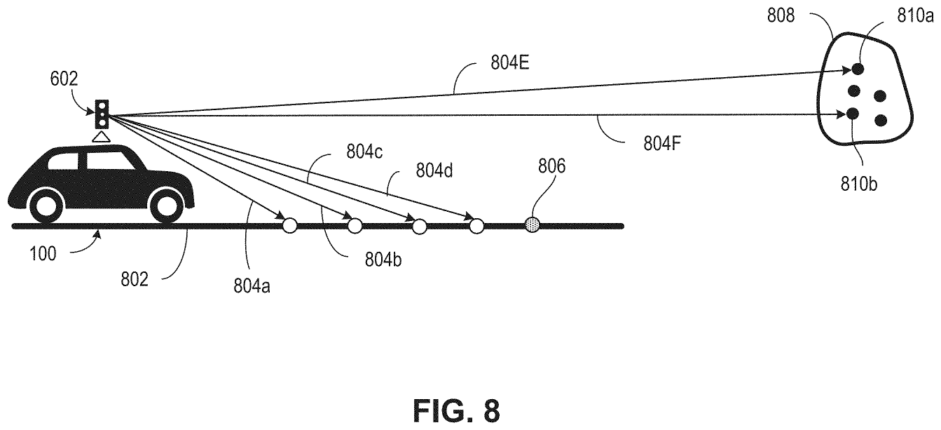

FIG. 8 is a block diagram illustrating the operation of the LiDAR system 602 in additional detail, in accordance with one or more embodiments. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

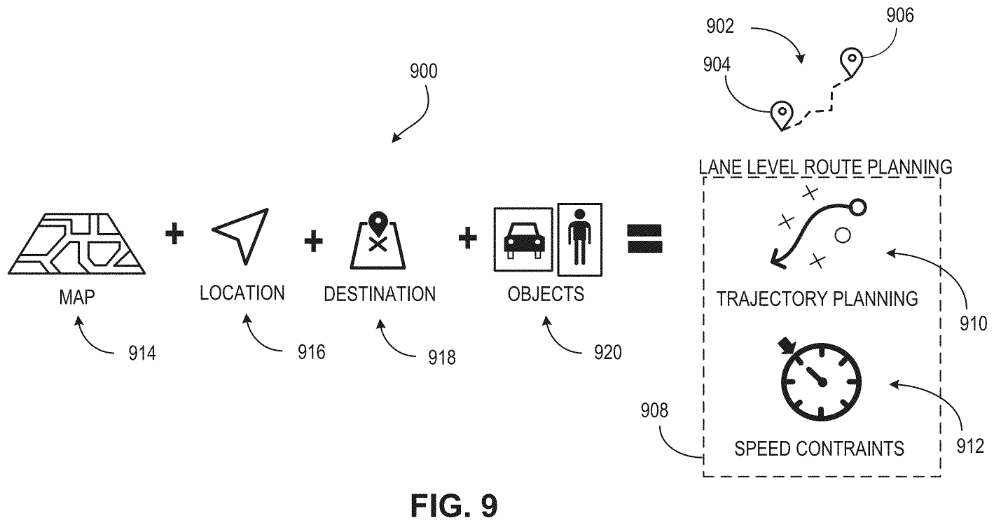

FIG. 9 is a block diagram 900 illustrating of the relationships between inputs and outputs of a planning module 404 (e.g., as shown in FIG. 4), in accordance with one or more embodiments. In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In an embodiment, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

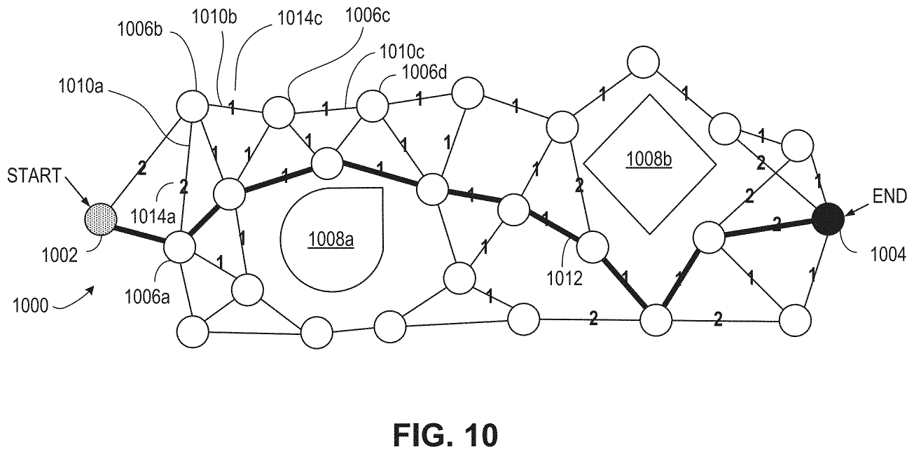

FIG. 10 illustrates a directed graph 1000 used in path planning, e.g., by the planning module 404 (FIG. 4), in accordance with one or more embodiments. In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

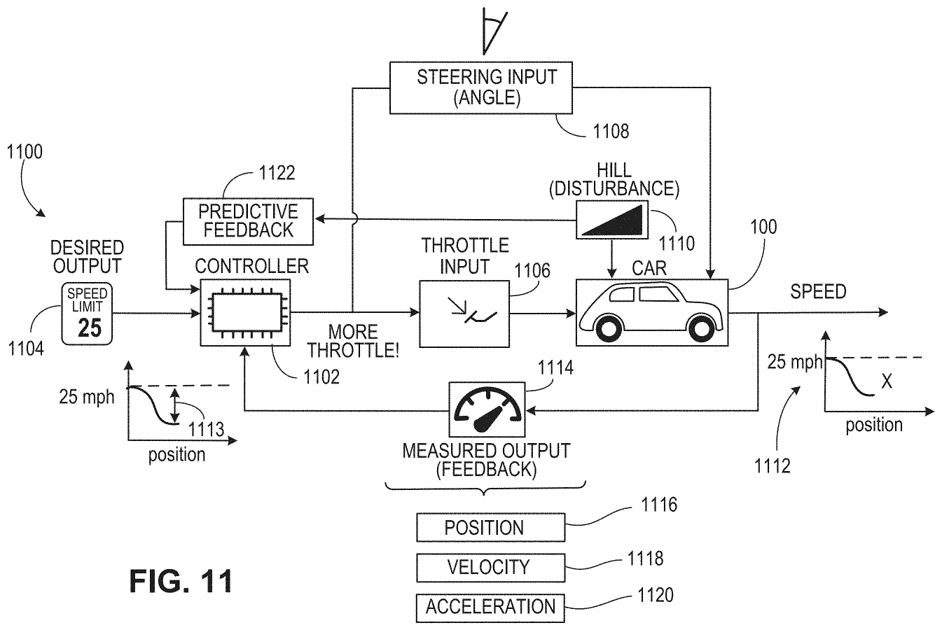

FIG. 11 is a block diagram 1100 illustrating the inputs and outputs of a control module 406 (e.g., as shown in FIG. 4), in accordance with one or more embodiments. A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 210, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

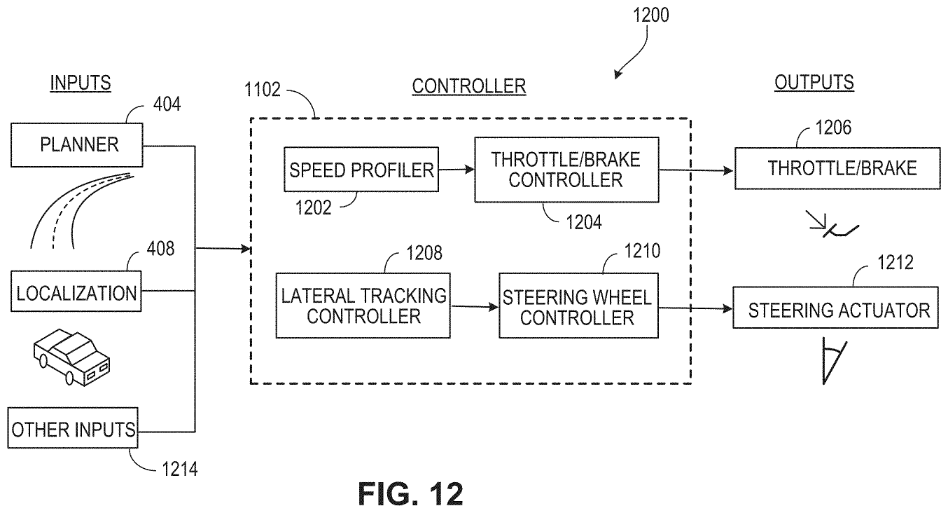

FIG. 12 is a block diagram 1200 illustrating the inputs, outputs, and components of the controller 1102, in accordance with one or more embodiments. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1204 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Adaptive Point Cloud Generation for Autonomous Vehicles

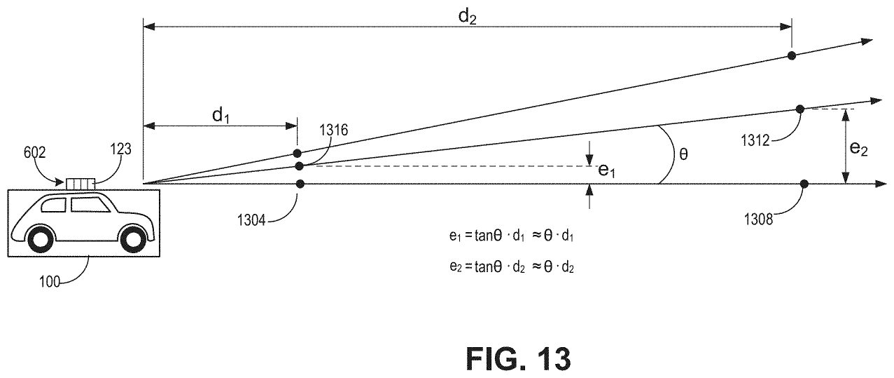

FIG. 13 is a schematic illustrating an example of adaptive point cloud generation for the AV 100, in accordance with one or more embodiments. The AV 100 is illustrated and described in more detail with reference to FIG. 1. The AV 100 uses at least one processor to receive multiple LiDAR points 1304, 1308, 1312, 1316 from a LiDAR system of the AV 100. The processor is the same as or similar to the processor 146, illustrated and described in more detail with reference to FIG. 1. For example, the processor 146 can be part of the planning module 404 or the perception module 402, illustrated and described in more detail with reference to FIG. 4. The LiDAR system 602 includes at least one LiDAR sensor 123. The LiDAR system 602 and the process of receiving LiDAR points from LiDAR sensors is illustrated and described in more detail with reference to FIG. 6. The LiDAR sensor 123 is illustrated and described in more detail with reference to FIG. 1.

The multiple LiDAR points 1304, 1308, 1312, 1316 represent at least one object in an environment traveled by the AV 100. An example of such an object is the vehicle 193, illustrated and described in more detail with reference to FIG. 1. The environment is the same as or similar to the environment 190, illustrated and described in more detail with reference to FIG. 1. The LiDAR sensor 123 plays an important role in object recognition, segmentation, and localization. However, the raw (unprocessed) LiDAR points acquired using the LiDAR sensor 123 can sometimes contain redundant information and a non-uniform density distribution. Therefore, the density of the LiDAR points 1304, 1316 that are closer to the LiDAR system 602 can be greater than the density of the LiDAR points 1308, 1312 that are further away from the LiDAR system 602. The embodiments disclosed herein reduce the density variation in the LiDAR data acquired by the LiDAR system 602 while maintaining the accuracy of downstream systems (e.g., a planning module) during operation of the AV 100. An example planning module 404 is illustrated and described in more detail with reference to FIG. 4.

In some embodiments, the processor determines a Euclidean distance d₁ of each LiDAR point (for example, LiDAR point 1304) of the multiple LiDAR points 1304, 1308, 1312, 1316. The Euclidean distance d₁ of the LiDAR point 1304 refers to the Euclidean distance between the LiDAR point 1304 and the LiDAR system 602. LiDAR points located at a greater distance as compared to other LiDAR points (e.g., LiDAR points 1308, 1312) are more sparse. Hence, the further away LiDAR points 1308, 1312 carry more information. For example, the Euclidean distance d₂ of the LiDAR point 1308 refers to the Euclidean distance between the LiDAR point 1308 and the LiDAR system 602. In the scan lines illustrated in FIG. 13, the distance (for example, distance e₁) between two consecutive LiDAR points 1304, 1316 is proportional to the distance d₁ from the LiDAR system 602 to the object (for example, vehicle 193). As illustrated in FIG. 13, e₁=tan Θ×d₁, where Θ denotes the angle between the two scan lines corresponding to the LiDAR points 1304, 1316. Hence, because tan Θ≈Θ, e₁≈Θ×d₁. Similarly, e₂=tan Θ×d₂, where Θ denotes the angle between the two scan lines corresponding to the LiDAR points 1308, 1312. Hence, because tan Θ≈Θ, therefore e₂≈Θ×d₂.

The processor compares the Euclidean distance d₁ of each LiDAR point (e.g., the LiDAR point 1304) with a respective sampled Euclidean distance dᵤ from a standard normal distribution of Euclidean distances. In some embodiments, the respective sampled Euclidean distance dᵤ is a random number or random variable taking values between 0 and dₘₐₓ. Here, dₘₐₓ refers to the range of the LiDAR system 602, sometimes referred to as the “the maximum unambiguous measurement range.” The range dₘₐₓ is limited by the characteristics of the emitted light 604 from the LiDAR system 602. The emitted light 604 is illustrated and described in more detail with reference to FIG. 6.

In some embodiments, the processor determines the measurement range dₘₐₓ of the LiDAR system 602 based on the speed of light (c) and a pulse-repetition-frequency (PRF) of the LiDAR sensor 123. The LiDAR system 602 emits light 604 and an echo from the target object (e.g., vehicle 193) is received each time a pulse of the light 604 is transmitted. The higher the PRF, more of the object can be painted. “Painting” an object (e.g., the vehicle 193) refers to generating a three-dimensional (3D) representation of the object based on the light 604 that bounces back from the object. The reflected light 604 is used to create a point cloud (the 3D representation) that represents the object.

The emitted light 604 of the LiDAR sensor 123 travels at the speed of light, c. As a result the distance (denoted generally as dᵢ) between the LiDAR sensor 123 and the target object is given by dᵢ=c×t/2, where t denotes the time between emitting the light 604 and receiving the echo. The time (t) is divided by two because the light 604 has to travel the distance dᵢ in both directions. When pulses of the LiDAR light 604 repeat, to avoid measurement ambiguities of the light, each pulse of the light 604 should return to the LiDAR sensor 123 before the next pulse is emitted. For a given PRF, this time limit can be determined as 1/PRF. Hence, using speed of light (c), the maximum distance the light 604 can travel is determined as (c/PRF) and the maximum distance (maximum unambiguous measurement range) between the LiDAR sensor 123 and the target object is determined as dₘₐₓ=½×c/PRF.

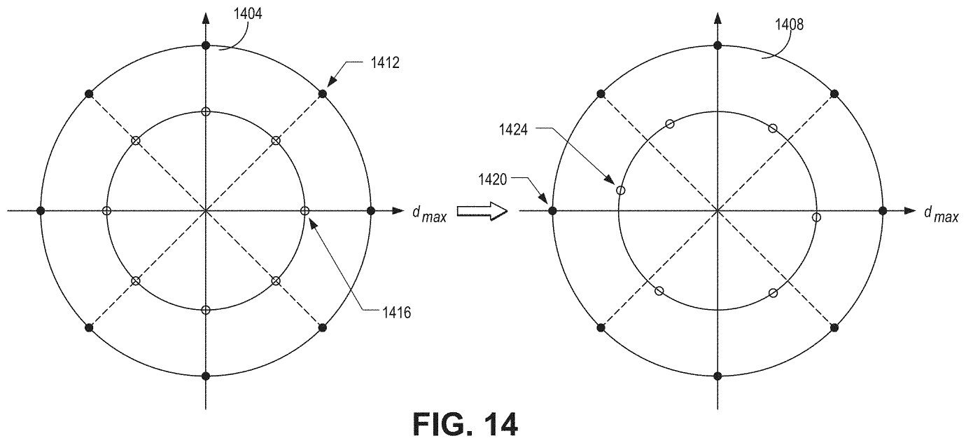

In some embodiments, the respective sampled Euclidean distance is a constant, k. For example, the AV 100 receives the LiDAR points 1304, 1308, 1312, 1316 from the LiDAR system 602 as illustrated with reference to FIG. 13. The processor determines the Euclidean distance dᵢ of each LiDAR point (e.g., LiDAR point 1304). The processor can determine a likelihood of adding a LiDAR point 1304 to an output point cloud based on a density variation of the multiple LiDAR points 1304, 1308, 1312, 1316. An example output point cloud 1408 is illustrated and described in more detail with reference to FIG. 14. For example, statistical processing is used to determine the likelihood of retaining a LiDAR point based on distribution characteristics of the multiple LiDAR points 1304, 1308, 1312, 1316.

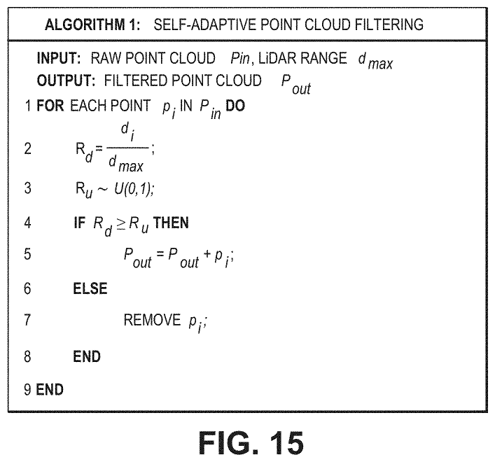

For each LiDAR point, the processor determines a probability of retaining the LiDAR point based on its Euclidean distance dᵢ. In some embodiments, the processor compares the Euclidean distance dᵢ of each LiDAR point with the constant, k. The further away LiDAR points are more sparse and carry more information. Hence, the probability of retaining a LiDAR point increases as its Euclidean distance dᵢ increases until the Euclidean distance dᵢ equals the constant, k. The probability of retaining the LiDAR point is 1 when dᵢ equals or exceeds the constant, k. The value of the constant, k, can be determined and adjusted based on experimental results as shown in FIGS. 15-23. For example, the constant, k, can be set to (dₘₐₓ/2), (dₘₐₓ/4), or some other value. The value of the constant, k, can also be adjusted based on changes in computational runtime and the number of LiDAR points desired in the output point cloud. For example, the larger the value of the constant, k, the fewer LiDAR points will appear in the output point cloud. Thus, the density of the output point cloud and the complexity of processing the output point cloud for AV operation reduces. When the Euclidean distance dᵢ of a LiDAR point is less than the constant, k, the processor does not include the LiDAR point in the output point cloud.

In other embodiments, as illustrated and described in more detail with reference to FIG. 15, the respective sampled Euclidean distance is a random variable between 0 and 1. In such embodiments, the respective sampled Euclidean distance is a Euclidean distance ratio R_{d}. The processor determines a Euclidean distance ratio R_{d} for each LiDAR point (e.g., the LiDAR point 1304). The Euclidean distance ratio R_{d} is a ratio of the distance dᵢ (between the LiDAR system 602 and the LiDAR point 1304) to the LiDAR range (dₘₐₓ). The processor compares the Euclidean distance ratio (R_{d}=dᵢ/dₘₐₓ) with a sampled Euclidean distance ratio Rᵤ from a standard normal distribution of Euclidean distance ratios. The Euclidian distance ratio R_{d} is a measure of how far each LiDAR point 1304 is from the LiDAR sensor 123 measuring it. The sampled Euclidean distance ratio Rᵤ is a random variable between 0 and 1 that reflects a Gaussian distribution of distance ratios.

In response to the Euclidean distance (denoted generally by dᵢ) of a LiDAR point (e.g., the LiDAR point 1304) being less than the respective sampled Euclidean distance dᵤ, the processor removes the LiDAR point 1304 from the multiple LiDAR points 1304, 1308, 1312, 1316 to generate an output point cloud. An example output point cloud 1408 is illustrated and described in more detail with reference to FIG. 14. The embodiments described reduce the computation complexity of processing the multiple LiDAR points 1304, 1308, 1312, 1316 by down-sampling and filtering the multiple LiDAR points 1304, 1308, 1312, 1316 as described. Each LiDAR point that is further away from the LiDAR sensor 123 than the distance dᵤ given by the random variable is aggregated into the output point cloud. The processor operates the AV 100 based on the output point cloud. For example, the processor can be part of the control module 406 illustrated and described in more detail with reference to FIG. 4. The output point cloud generated is a reduced-density point cloud that is suitable for further processing as well.

FIG. 14 is a schematic illustrating example LiDAR point clouds 1404, 1408 for an AV, in accordance with one or more embodiments. The AV is the same as or similar to the AV 100, illustrated and described in more detail with reference to FIGS. 1, 13. The AV receives an input set of LiDAR points (e.g., the LiDAR points 1412, 1416) from a LiDAR system of the AV. The LiDAR system is the same as or similar to the LiDAR system 602, illustrated and described in more detail with reference to FIGS. 6, 13. The input set of LiDAR points constitutes the point cloud 1404 shown in FIG. 14. The point cloud 1404 is a multi-channel LiDAR scan raw point cloud. The point cloud 1404 acquired using the LiDAR system can have redundant information and a non-uniform density distribution. For example, the LiDAR points 1412 that are further away from the LiDAR system 602 are more sparse as compared to the LiDAR points 1416 that are closer to the LiDAR system 602. As such, the LiDAR points 1416 that are closer to the LiDAR system are more dense. Hence, the point cloud 1404 and the LiDAR points 1412, 1416 have a first density variation. The symbol, dₘₐₓ, shown in FIG. 14 refers to the LiDAR range described in more detail with reference to FIG. 13.

In response to the Euclidean distance dᵢ of a LiDAR point (e.g., the LiDAR point 1416) of the multiple LiDAR points 1412, 1416 being less than a respective sampled Euclidean distance (dᵤ) from a standard normal distribution of Euclidean distances, the AV removes the LiDAR point 1416 from the multiple LiDAR points 1412, 1416 to generate an output point cloud 1408. The Euclidean distance, dᵢ, and respective sampled Euclidean distance, dᵤ, are described in more detail with reference to FIG. 13.

In the point cloud 1408, the density of the LiDAR points 1420 that are further away from the LiDAR system is closer to the density of the LiDAR points 1424 that are closer to the LiDAR system. Thus, the multiple LiDAR points 1412, 1416 (point cloud 1404) have a first density variation and the point cloud 1408 has a second density variation less than the first density variation. In some embodiments, generating the point cloud 1408 includes down-sampling, by the AV, the received LiDAR points 1412, 1416 to generate the second density variation. Because most of the LiDAR points (e.g., LiDAR points 1416) are closer to a LiDAR sensor of the LiDAR system, the closer LiDAR points 1416 have more redundant information. The LiDAR sensor is the same as or similar to the LiDAR sensor 123, illustrated and described in more detail with reference to FIG. 1. The multiple LiDAR points 1412, 1416 that are received from the LiDAR system have a first density distribution having a larger variation. This is because the multiple LiDAR points 1412, 1416 include denser-spaced LiDAR points 1416 located closer to the LiDAR system as well as sparser-spaced LiDAR points 1412 located further away from the LiDAR system.

In some embodiments, removing a LiDAR point 1416 from the multiple LiDAR points 1412, 1416 is based on the first density variation. For example, most LiDAR points (e.g., LiDAR points 1416) are closer to the LiDAR sensor; hence the closer LiDAR points 1416 have more redundant information. A subset of the multiple LiDAR points 1412, 1416 that are retained as the point cloud 1408 has a second density variation less than the first density variation because the density of the LiDAR points has been smoothed by down-sampling.

In some embodiments, the AV segments the point cloud 1408 based on the second density variation to identify an object. The object is the same as or similar to the vehicle 193, illustrated and described in more detail with reference to FIG. 1. For example, the point cloud 1408 can be segmented into a foreground and a background. LiDAR points 1420, 1424 having similar characteristics can be segmented into homogeneous regions for locating and recognizing objects, classification, and feature extraction. For example, the AV can build a graph from the point cloud 1408 and cluster the graph to produce a segmentation using smoothness or concavity along boundaries. Operating the AV can further be based on the segmented point cloud 1408 to avoid a collision with the object. Object classification is performed by a perception module that is the same as or similar to the perception module 402, illustrated and described in more detail with reference to FIG. 4. Path planning (to avoid collisions) is performed by a planning module, which is the same as or similar to the planning module 404, illustrated and described in more detail with reference to FIG. 4.

In some embodiments, the AV reduces an amount of noise in the point cloud 1408 based on the second density variation. For example, statistical noise filtering can be used (e.g., kernel clustering) to smooth outliers from a noisy point cloud based on the second density variation. The LiDAR points representing noise will have a lower density than non-noise LiDAR points and can thus be removed. In some embodiments, the AV smoothes the point cloud 1408 based on the second density variation. For example, a projection operator can be used on the point cloud 1408 to project a subset of the point cloud 1408 onto a new point cloud to reduce noise. The second density variation is incorporated into the operator to produce an evenly distributed new point cloud for operation of the AV using the planning module and a control module. The control module is the same as or similar to the control module 406, illustrated and described in more detail with reference to FIG. 4.

FIG. 15 illustrates an example process for adaptive point cloud generation for an AV, in accordance with one or more embodiments. The AV is the same as or similar to the AV 100, illustrated and described in more detail with reference to FIG. 1. The AV receives a raw input point cloud denoted by Pᵢₙ. The input point cloud, Pᵢₙ, is the same as or similar to the point cloud 1404, illustrated and described in more detail with reference to FIG. 14. The input point cloud, Pᵢₙ, includes multiple LiDAR points received from a LiDAR system of the AV. The multiple LiDAR points are the same as or similar to the LiDAR points 1412, 1416, illustrated and described in more detail with reference to FIG. 14. The LiDAR system is the same as or similar to the LiDAR system 602, illustrated and described in more detail with reference to FIG. 6. Each of the multiple LiDAR points is denoted by pᵢ as shown in FIG. 15. In some embodiments, the LiDAR range dₘₐₓ is also an input to the example process shown in FIG. 15. In other embodiments, the LiDAR range dₘₐₓ is determined using the methods described with reference to FIG. 13. The output of the example process shown in FIG. 15 is a filtered point cloud denoted by Pₒᵤₜ. The point cloud, Pₒᵤₜ, is the same as or similar to the output point cloud 1408, illustrated and described in more detail with reference to FIG. 14.

For each LiDAR point, pᵢ, in the raw input point cloud, Pᵢₙ, the AV determines a Euclidean distance ratio, R_{d}. The Euclidean distance ratio, R_{d}, is a ratio of the distance, dᵢ (between the LiDAR system and the LiDAR point pᵢ) to the LiDAR range, dₘₐₓ. Thus, as shown in FIG. 15, R_{d}=/dₘₐₓ. The Euclidian distance ratio, R_{d}, is a measure of how far a LiDAR point, pᵢ, is from a LiDAR sensor measuring it. The LiDAR sensor is the same as or similar to the LiDAR sensor 123, illustrated and described in more detail with reference to FIG. 1.

The AV generates a random number, Rᵤ, that has a value of between 0 and 1. The random number, Rᵤ, represents a sampled Euclidean distance ratio from a standard normal distribution of Euclidean distance ratios. The sampled ratio Rᵤ is a random variable between 0 and 1 that reflects a Gaussian distribution of distance ratios. The AV compares the values of R_{d} and Rᵤ to down-sample the LiDAR points, pᵢ, by distance, such that a LiDAR point that is closer to the LiDAR system is more likely to be removed than a LiDAR point that is further away from the LiDAR system. Further away LiDAR points are more sparse and hence, further away LiDAR points carry more information.

In response to R_{d} being greater than or equal to Rᵤ, the LiDAR point, pᵢ, is added to the generated output point cloud, Pₒᵤₜ. Hence, because processing all the raw input LiDAR points, pᵢ, can be computationally expensive, the input point cloud, Pᵢₙ, is down-sampled and filtered. A LiDAR point, pᵢ, that is further away from the LiDAR sensor than the Euclidean distance given by the random variable, Rᵤ, is aggregated into a subset of LiDAR points to generate the point cloud, Pₒᵤₜ. A LiDAR point, pᵢ, that is closer to the LiDAR sensor than the Euclidean distance given by the random variable, Rᵤ, is removed. The point cloud, Pₒᵤₜ, generated is used for further processing and operating the AV.

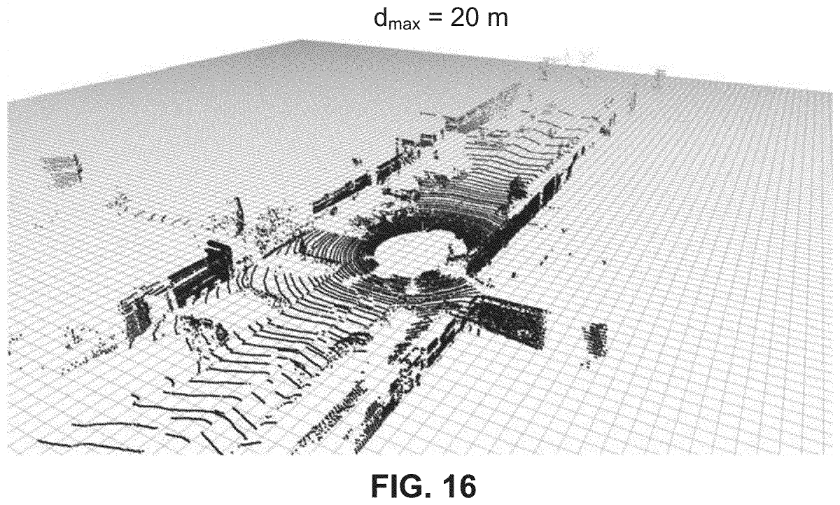

FIG. 16 illustrates an example point cloud generated using single LiDAR scan and adaptive point cloud generation for an AV, in accordance with one or more embodiments. Generally, FIGS. 16-19 are generated from a single scan LiDAR point cloud, and then the process of FIG. 15 as described herein with different settings (e.g., different LiDAR ranges, the size of the output point cloud, or different runtimes). The AV is the same as or similar to the AV 100, illustrated and described in more detail with reference to FIG. 1. A single LiDAR scan can be used to tradeoff the runtime and accuracy. The experiments to generate the example point cloud generated in FIG. 16 used a LiDAR range (dₘₐₓ) of 20 meters (m). The number of down-sampled LiDAR points (output point cloud) were 100,000 and the runtime for the experiment was 5000 ms (5 seconds). The output point cloud is the same as or similar to the point cloud 1408, illustrated and described in more detail with reference to FIG. 14.

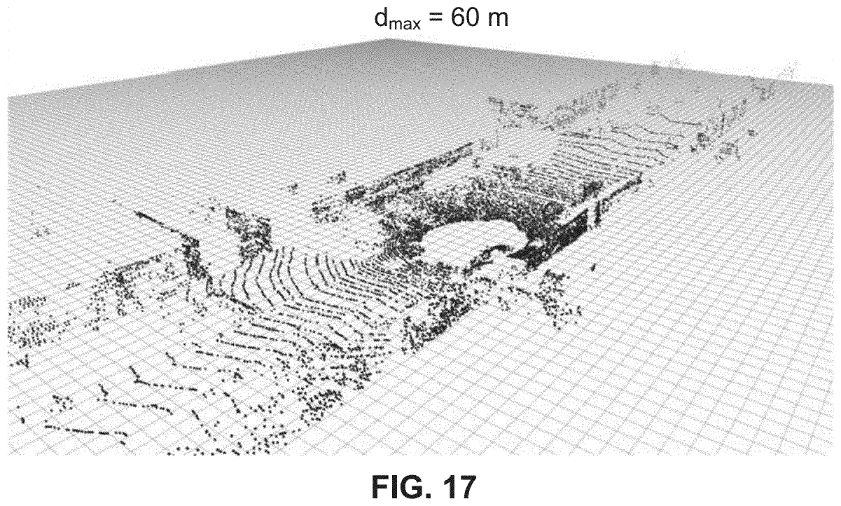

FIG. 17 illustrates an example point cloud generated using single LiDAR scan and adaptive point cloud generation for an AV, in accordance with one or more embodiments. The AV is the same as or similar to the AV 100, illustrated and described in more detail with reference to FIG. 1. The experiments to generate the example point cloud generated in FIG. 17 used a LiDAR range (dₘₐₓ) of 60 m. The number of down-sampled LiDAR points (output point cloud) were 30,000 and the runtime for the experiment was 600 ms. The output point cloud is the same as or similar to the point cloud 1408, illustrated and described in more detail with reference to FIG. 14.

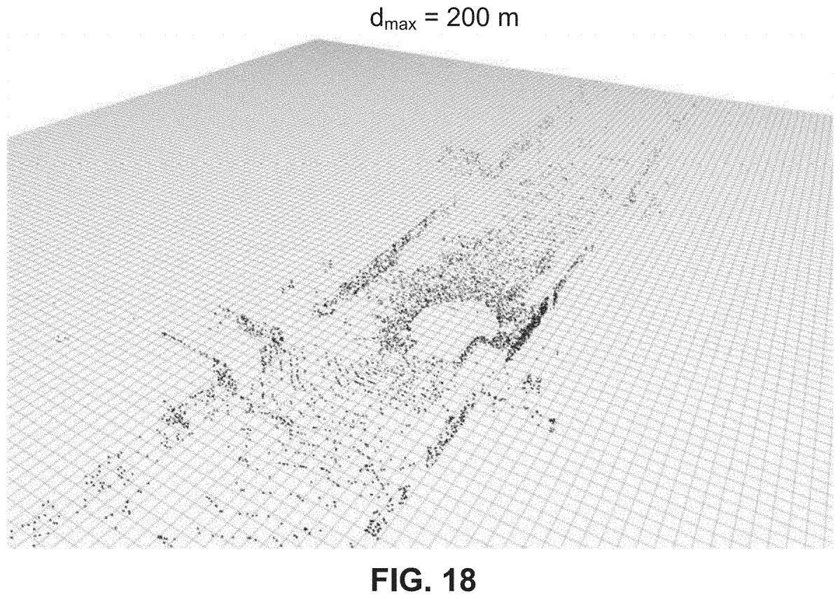

FIG. 18 illustrates an example point cloud generated using single LiDAR scan and adaptive point cloud generation for an AV, in accordance with one or more embodiments. The AV is the same as or similar to the AV 100, illustrated and described in more detail with reference to FIG. 1. The experiments to generate the example point cloud generated in FIG. 18 used a LiDAR range (dₘₐₓ) of 200 m. The number of down-sampled LiDAR points (output point cloud) were 7,000 and the runtime for the experiment was 165 ms. The output point cloud is the same as or similar to the point cloud 1408, illustrated and described in more detail with reference to FIG. 14.

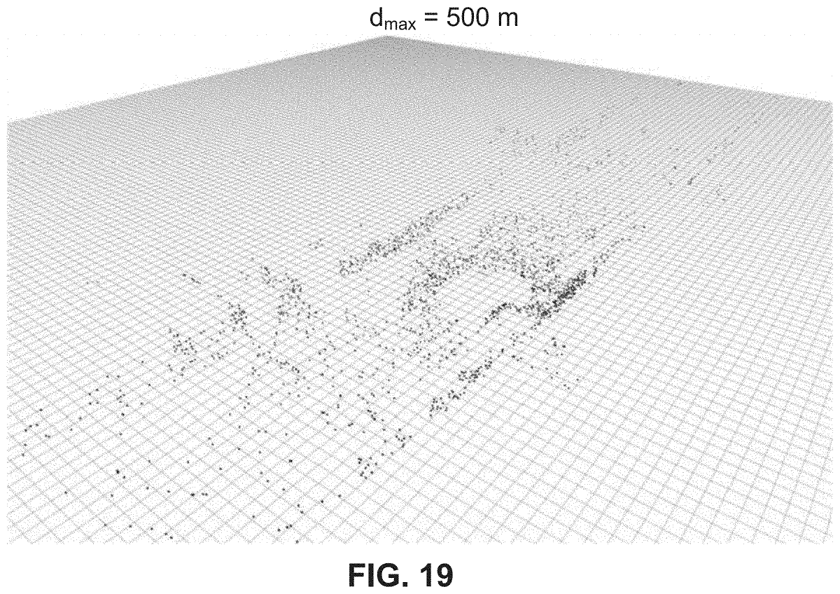

FIG. 19 illustrates an example point cloud generated using single LiDAR scan and adaptive point cloud generation for an AV, in accordance with one or more embodiments. The AV is the same as or similar to the AV 100, illustrated and described in more detail with reference to FIG. 1. The experiments to generate the example point cloud generated in FIG. 19 used a LiDAR range (dₘₐₓ) of 500 m. The number of down-sampled LiDAR points (output point cloud) were 2,000 and the runtime for the experiment was 60 ms. The output point cloud is the same as or similar to the point cloud 1408, illustrated and described in more detail with reference to FIG. 14. Hence, as shown in FIGS. 16-19, an efficient trade-off between running time and accuracy is achieved using the disclosed embodiments.

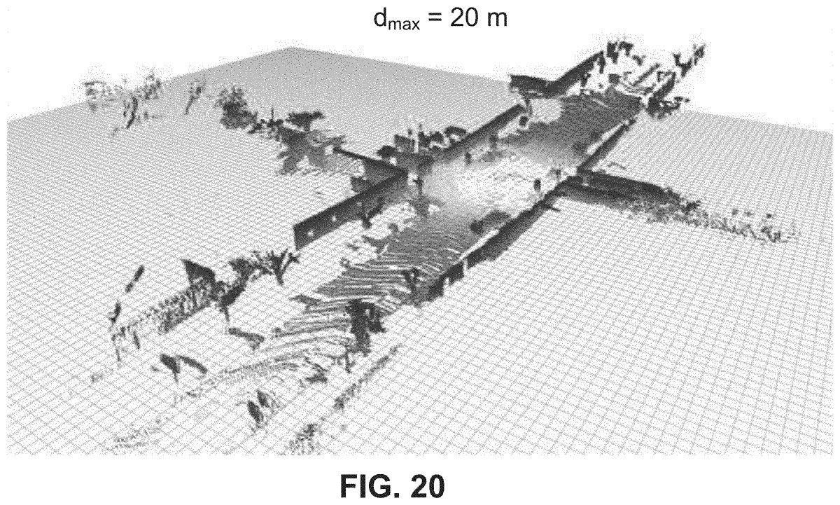

FIG. 20 illustrates an example point cloud generated using accumulated LiDAR scans and adaptive point cloud generation for an AV, in accordance with one or more embodiments. Generally, FIGS. 20-23 are based on use of accumulated LiDAR scans and the adaptive point cloud generation process of FIG. 15 using different settings (e.g., different filtering ranges, different down-sampled LiDAR points, and different runtimes). The AV is the same as or similar to the AV 100, illustrated and described in more detail with reference to FIG. 1. Accumulated LiDAR scans can be used to improve the resolution of a LiDAR sensor along its sparse axis. Using accumulated LiDAR scans, information(accuracy) in the output point cloud is preserved as well as more efficiency (running time) is achieved. The output point cloud is the same as or similar to the point cloud 1408, illustrated and described in more detail with reference to FIG. 14. The experiments to generate the example point cloud generated in FIG. 20 used a LiDAR range (dₘₐₓ) of 20 m. The number of down-sampled LiDAR points (output point cloud) were 100,000 and the runtime for the experiment was 5000 ms (5 seconds).

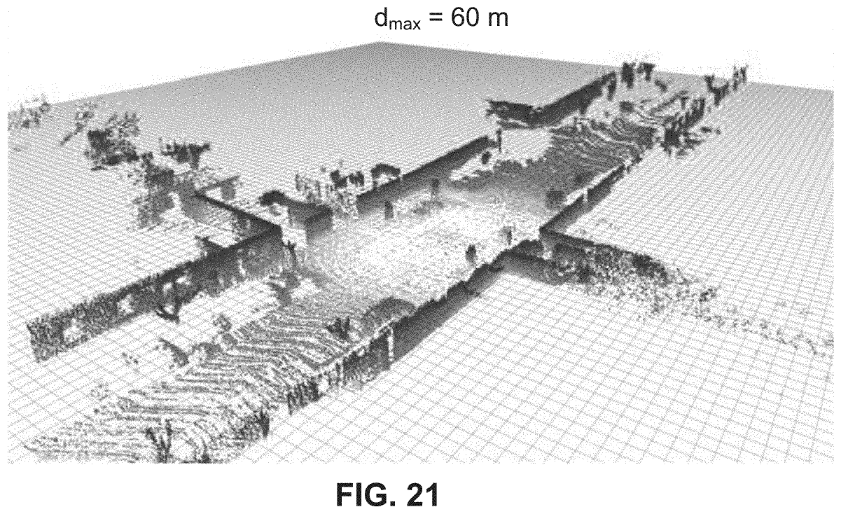

FIG. 21 illustrates an example point cloud generated using accumulated LiDAR scans and adaptive point cloud generation for an AV, in accordance with one or more embodiments. The AV is the same as or similar to the AV 100, illustrated and described in more detail with reference to FIG. 1. The experiments to generate the example point cloud generated in FIG. 21 used a LiDAR range (dₘₐₓ) of 60 m. The number of down-sampled LiDAR points (output point cloud) were 30,000 and the runtime for the experiment was 600 ms. The output point cloud is the same as or similar to the point cloud 1408, illustrated and described in more detail with reference to FIG. 14.

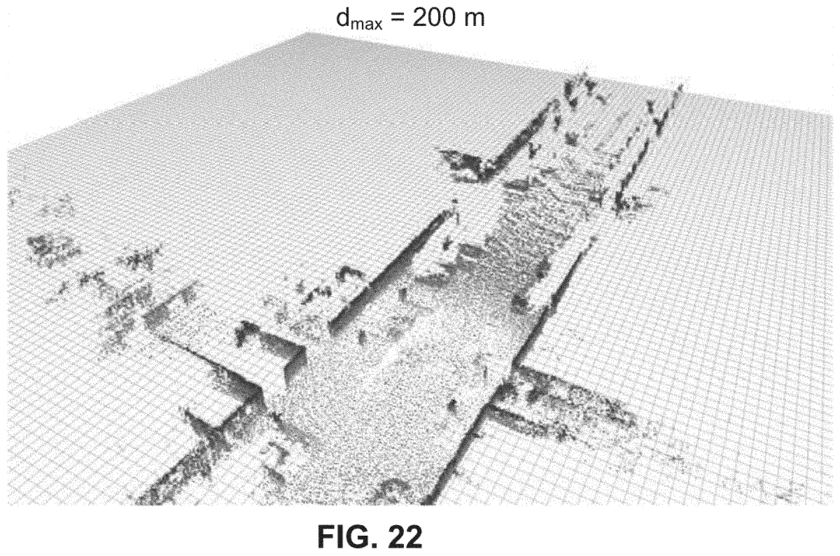

FIG. 22 illustrates an example point cloud generated using accumulated LiDAR scans and adaptive point cloud generation for an AV, in accordance with one or more embodiments. The AV is the same as or similar to the AV 100, illustrated and described in more detail with reference to FIG. 1. The experiments to generate the example point cloud generated in FIG. 22 used a LiDAR range (dₘₐₓ) of 200 m. The number of down-sampled LiDAR points (output point cloud) were 7,000 and the runtime for the experiment was 165 ms. The output point cloud is the same as or similar to the point cloud 1408, illustrated and described in more detail with reference to FIG. 14.

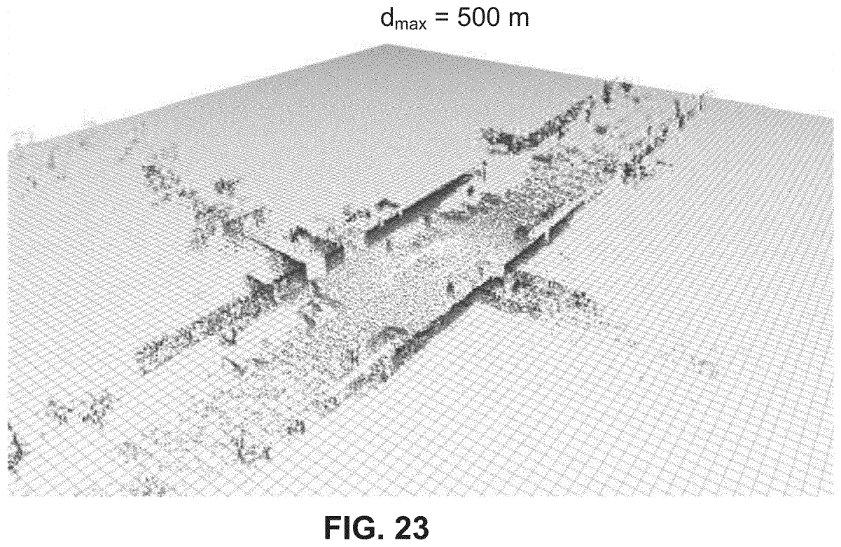

FIG. 23 illustrates an example point cloud generated using accumulated LiDAR scans and adaptive point cloud generation for an AV, in accordance with one or more embodiments. The AV is the same as or similar to the AV 100, illustrated and described in more detail with reference to FIG. 1. The experiments to generate the example point cloud generated in FIG. 23 used a LiDAR range (dₘₐₓ) of 500 m. The number of down-sampled LiDAR points (output point cloud) were 2,000 and the runtime for the experiment was 60 ms. The output point cloud is the same as or similar to the point cloud 1408, illustrated and described in more detail with reference to FIG. 14. Hence, as shown in FIGS. 20-23, an efficient trade-off between running time and accuracy is achieved using the disclosed embodiments. The embodiments disclosed herein provide probabilistic methods that improve the overall robustness of the LiDAR point clouds without introducing many parameters. The methods are efficient and have an O(n) linear time complexity, which is suitable for real-time point cloud processing by an AV. The methods disclosed are broadly applicable to localization, perception, and prediction tasks that depend on LiDAR point clouds. The methods also provide an effective and efficient pre-processing step for applications such as point cloud segmentation, de-noising, and smoothing.

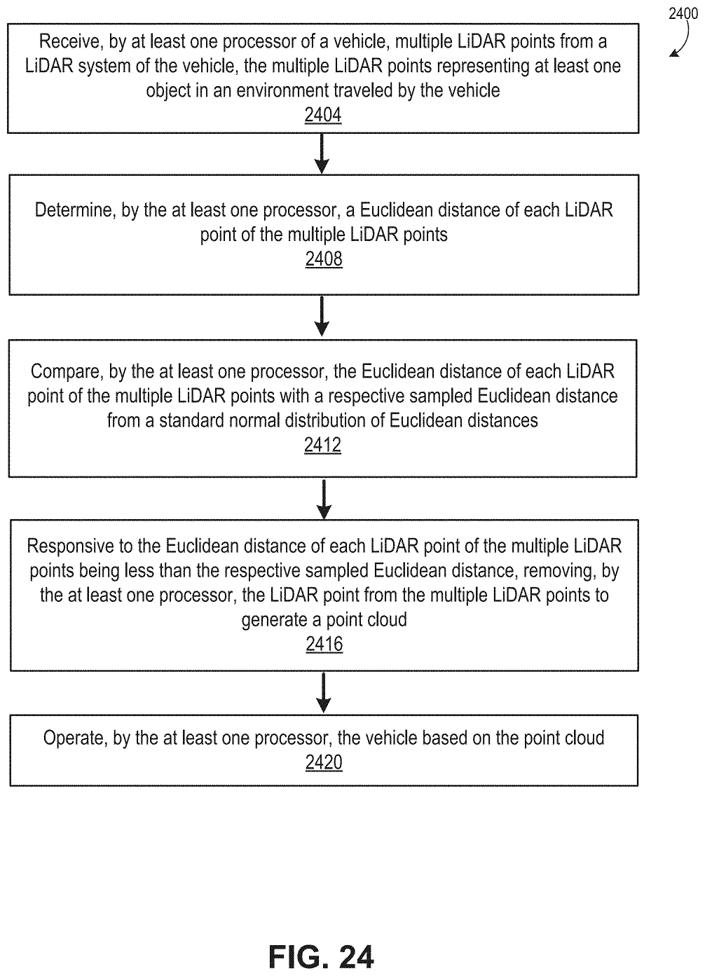

FIG. 24 is a flow diagram illustrating a process 2400 for adaptive point cloud generation for an AV, in accordance with one or more embodiments. The AV is the same as or similar to the AV 100, illustrated and described in more detail with reference to FIG. 1. In an embodiment, the process of FIG. 24 is performed by the AV. Particular entities, for example, a perception module or a planning module perform some or all of the steps of the process in other embodiments. Likewise, embodiments may include different and/or additional steps, or perform the steps in different orders. The perception module and planning module are the same as or similar to the perception module 402 and the planning module 404, respectively, illustrated and described in more detail with reference to FIG. 4.

The AV uses at least one processor to receive (2404) multiple LiDAR points from a LiDAR system of the AV. The processor is the same as or similar to the processor 146, illustrated and described in more detail with reference to FIG. 1. The multiple LiDAR points are is the same as or similar to the LiDAR points 1404, illustrated and described in more detail with reference to FIG. 14. An example LiDAR system 602 and a process of receiving LiDAR points (LiDAR data) from a LiDAR system are illustrated and described in more detail with reference to FIG. 6. The multiple LiDAR points represent at least one object (for example, a vehicle) in an environment traveled by the AV 100. An example vehicle 193 and example environment 190 are illustrated and described in more detail with reference to FIG. 1. The LiDAR system thus plays an important role in localization of the object. In some embodiments, the multiple LiDAR points have a first density variation. The multiple LiDAR points acquired using the LiDAR system, therefore, can have redundant information and a non-uniform density distribution.

The AV uses the processor to determine (2408) a Euclidean distance, dᵢ, of each LiDAR point. An example Euclidean distance, d₁, of an example LiDAR point 1304 is illustrated and described in more detail with reference to FIG. 13. The Euclidean distance, dᵢ, is the distance from the LiDAR system to the LiDAR point. In some embodiments, the LiDAR system includes at least one LiDAR sensor. An example LiDAR sensor 123 of a LiDAR system is illustrated and described in more detail with reference to FIG. 1. The processor determines the measurement range of the LiDAR system based on the speed of light and a pulse-repetition-frequency of the LiDAR sensor. The processor 146 compares a measurement range of the LiDAR system with a distance (e.g., dᵢ) from the LiDAR system to the object.

The AV 100 uses the processor to compare (2412) the Euclidean distance, dᵢ, of each LiDAR point with a respective sampled Euclidean distance, dᵤ, from a standard normal distribution of Euclidean distances. In some embodiments, the respective sampled Euclidean distance, dᵤ, is a random variable that reflects a Gaussian distribution of distances. The processor can also generate the respective sampled Euclidean distance, dᵤ, as a random or pseudorandom number.

In response to the Euclidean distance dᵢ of a LiDAR point being less than the respective sampled Euclidean distance, dᵤ, the AV uses the processor to remove (2416) the LiDAR point from the multiple LiDAR points to generate an output point cloud. The output point cloud is the same as or similar to the example point cloud 1408, illustrated and described in more detail with reference to FIG. 14. In some embodiments, the output point cloud has a second density variation less than the first density variation. Generating the output point cloud can include down-sampling the multiple LiDAR points to generate the second density variation. Removing the LiDAR point from the multiple LiDAR points is based on the first density variation. The processor can determine a likelihood of adding the LiDAR point to the output point cloud based on the first density variation.

The AV uses the processor to operate (2420) the AV based on the output point cloud. The output point cloud generated is a reduced-density point cloud that is suitable for further processing as well. A control module is used to operate the AV 100. An example control module 406 is illustrated and described in more detail with reference to FIG. 4. For example, the processor segments the output point cloud based on the second density variation to identify the object, as illustrated and described in more detail with reference to FIGS. 13 and 14. Operating the AV is further based on the segmented point cloud to avoid a collision with the object. The processor can reduce an amount of noise in the output point cloud based on the second density variation. The processor can smooth the point cloud based on the second density variation.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

1. A method comprising:
receiving, by at least one processor of a vehicle, a plurality of LiDAR points from a LiDAR system of the vehicle, the plurality of LiDAR points representing at least one object in an environment traveled by the vehicle;
determining, by the at least one processor, a Euclidean distance of each LiDAR point of the plurality of LiDAR points;
comparing, by the at least one processor, the Euclidean distance of each LiDAR point of the plurality of LiDAR points with a respective sampled Euclidean distance from a standard normal distribution of Euclidean distances;
responsive to the Euclidean distance of each LiDAR point of the plurality of LiDAR points being less than the respective sampled Euclidean distance, removing, by the at least one processor, the LiDAR point from the plurality of LiDAR points to generate a point cloud; and
operating, by the at least one processor, the vehicle based on the point cloud.

2. The method of claim 1, wherein the plurality of LiDAR points has a first density variation and the point cloud has a second density variation less than the first density variation.

3. The method of claim 2, wherein generating the point cloud comprises down-sampling, by the at least one processor, the plurality of LiDAR points to provide the second density variation.

4. The method of claim 2, wherein removing the LiDAR point from the plurality of LiDAR points is based on the first density variation.

5. The method of claim 1, further comprising determining, by the at least one processor, a likelihood of adding the LiDAR point to the point cloud based on the first density variation.

6. The method of claim 1, further comprising comparing, by the at least one processor, a measurement range of the LiDAR system with a distance from the LiDAR system to the at least one object.

7. The method of claim 6, wherein the LiDAR system comprises at least one LiDAR, the method further comprising determining, by the at least one processor, the measurement range of the LiDAR system based on the speed of light and a pulse-repetition-frequency of the at least one LiDAR.

8. The method of claim 1, further comprising determining, by the at least one processor, the respective sampled Euclidean distance as a random number.

9. The method of claim 1, further comprising segmenting, by the at least one processor, the point cloud based on the second density variation to identify the at least one object.

10. The method of claim 9, wherein operating the vehicle is further based on the segmented point cloud to avoid a collision with the at least one object.

11. The method of claim 1, further comprising reducing, by the at least one processor, an amount of noise in the point cloud based on the second density variation.

12. The method of claim 1, further comprising smoothing, by the at least one processor, the point cloud based on the second density variation.

13. A vehicle comprising:
at least one computer processor; and
at least one non-transitory storage medium storing instructions which, when executed by the at least one computer processor, cause the at least one computer processor to:
receive a plurality of LiDAR points from a LiDAR system of the vehicle, the plurality of LiDAR points representing at least one object in an environment traveled by the vehicle;
determine a Euclidean distance of each LiDAR point of the plurality of LiDAR points;
compare the Euclidean distance of each LiDAR point of the plurality of LiDAR points with a respective sampled Euclidean distance from a standard normal distribution of Euclidean distances;
responsive to the Euclidean distance of each LiDAR point of the plurality of LiDAR points being less than the respective sampled Euclidean distance, remove the LiDAR point from the plurality of LiDAR points to generate a point cloud; and
operate the vehicle based on the point cloud.

14. The vehicle of claim 13, wherein the plurality of LiDAR points has a first density variation and the point cloud has a second density variation less than the first density variation.

15. The vehicle of claim 14, wherein instructions to generate the point cloud cause the at least one computer processor to down-sample the plurality of LiDAR points to generate the second density variation.

16. The vehicle of claim 14, wherein causing the at least one computer processor to remove the LiDAR point from the plurality of LiDAR points is based on the first density variation.

17. At least one non-transitory storage media storing instructions which, when executed by at least one computing device, cause the at least one computing device to:
receive a plurality of LiDAR points from a LiDAR system of the vehicle, the plurality of LiDAR points representing at least one object in an environment traveled by the vehicle;
determine a Euclidean distance of each LiDAR point of the plurality of LiDAR points;
compare the Euclidean distance of each LiDAR point of the plurality of LiDAR points with a respective sampled Euclidean distance from a standard normal distribution of Euclidean distances;
responsive to the Euclidean distance of each LiDAR point of the plurality of LiDAR points being less than the respective sampled Euclidean distance, remove the LiDAR point from the plurality of LiDAR points to generate a point cloud; and
operate the vehicle based on the point cloud.

18. The at least one non-transitory storage media of claim 17, wherein the plurality of LiDAR points has a first density variation and the point cloud has a second density variation less than the first density variation.

19. The at least one non-transitory storage media of claim 18, wherein instructions to generate the point cloud cause the at least one computing device to down-sample the plurality of LiDAR points to generate the second density variation.

20. The at least one non-transitory storage media of claim 18, wherein causing the at least one computing device to remove the LiDAR point from the plurality of LiDAR points is based on the first density variation.
